(19) United States
(12) Patent Application Publication
(10) Pub. No.: US 2005/0216340 A1
(43) Pub. Date: Sep. 29, 2005

(54) Biometric loyalty transaction system and method

(76) Inventors: John K. Schneider, Snyder, NY (US); Jack C. Kitchens, Tonawanda, NY (US); Leonard Pratt, Lockport, NY (US); Michael Amalfi, Webster, NY (US); Bryan Schutjer, Mansfield, OH (US)

Correspondence Address: HODGSON RUSS LLP, ONE M & T PLAZA, SUITE 2000, BUFFALO, NY, 14203-2391, US

(21) Appl. No.: 11/071,657

(22) Filed: Mar. 3, 2005

Related U.S. Application Data
(60) Provisional application No. 60/549,758, filed on Mar. 3, 2004.

(51) Int. Cl. G06F 17/60

(52) U.S. Cl. 705/14

(57) ABSTRACT

The invention may be embodied as a customer reward system or a method of rewarding a customer. A reward system may have a database of enrolled biometric samples, a point-of-sale station having a biometric-sample receiver, and a comparator in communication with the database and the point-of-sale station. In a method according to the invention, an enrollment station is provided and a first biometric sample is received along with an enrollment request. The first biometric sample may be enrolled in a database to provide an enrolled biometric sample. A point-of-sale station may be provided, and a second biometric sample may be received along with a point-of-sale request. The enrolled biometric sample may be retrieved and compared to the second biometric sample, and then a determination may be made as to whether the enrolled biometric sample is equivalent to the second biometric sample. If the enrolled biometric sample is determined to be equivalent to the second biometric sample, then the customer may be provided with a reward. However, if the enrolled biometric sample is determined not to be equivalent to the second biometric sample, then the reward may be denied.

### CROSS-REFERENCE TO RELATED APPLICATION

This application claims the benefit of priority to U.S. provisional patent application Ser. No. 60/549,758, filed on Mar. 3, 2004.

### FIELD OF THE INVENTION

The present invention relates to systems and methods of authorizing rewards.

### BACKGROUND OF THE INVENTION

Most modern point-of-sale systems provide the infrastructure to allow retail operators to offer customer loyalty or frequent shopping programs to their customers. At check-out, the point-of-sale system can provide a reward to the frequent customer by applying a discount to items being purchased, or providing a service to the customer. To obtain the reward, the customer is required to provide a token, usually a card, having an identification number thereon. The token may allow the retailer to collect information about the purchase that is being made by the customer. A problem with existing systems is encountered when the authorizing token is not immediately available. In such a circumstance either the customer does not receive the loyalty reward or the customer borrows a token from another customer. If the customer does not receive the loyalty reward, he may resent this and shop elsewhere in the future. If the customer borrows another's token, then the customer receives the reward, but the merchant receives inaccurate information. In both cases, the merchant loses out. A borrowed card results in false data entering the customer shopping history database. A forgotten card results in data being lost to the shopping history database. In both cases, marketing decisions based on information derived from the shopping history database will have some amount of error.

For these reasons, a tokenless reward system and method are needed. In such a system or method, the customer no longer has the requirement of carrying a token, such as a card or chip, that can be lost, stolen or forgotten, and the merchant has a means of positive identification for each customer without the expense and bookkeeping associated with operating a token-based system, and the costs associated with the issuance of the physical token itself.

### SUMMARY OF THE INVENTION

The present invention may be embodied as a customer reward system having a (a) database of enrolled biometric samples (b) a point-of-sale station having a biometric-sample receiver, and (c) a comparator in communication with the database and the point-of-sale station. The comparator may be capable of comparing a biometric sample received from the point-of-sale station to enrolled biometric samples in the database. The comparator may also be capable of determining whether the received biometric sample matches one of the enrolled biometric samples in the database, and capable of providing an authorization signal if the received biometric sample matches one of the biometric samples in the database, the authorization signal indicating that a reward should be provided.

The invention may be embodied as a method of rewarding a customer. In one such method an enrollment station is provided and a first biometric sample is received along with an enrollment request. The first biometric sample may be enrolled in a database to provide an enrolled biometric sample. A point-of-sale station may be provided, and a second biometric sample may be received along with a point-of-sale request. The enrolled biometric sample may be retrieved and compared to the second biometric sample, and then a determination may be made as to whether the enrolled biometric sample is equivalent to the second biometric sample. If the enrolled biometric sample is determined to be equivalent to the second biometric sample, then the customer may be provided with a reward. However, if the enrolled biometric sample is determined not to be equivalent to the second biometric sample, then the reward may be denied.

### BRIEF DESCRIPTION OF THE DRAWINGS

For a fuller understanding of the nature and objects of the invention, reference should be made to the accompanying drawings and the subsequent description. Briefly, the drawings are:

FIG. 1, which is a schematic depicting an embodiment of a system according to the invention; and

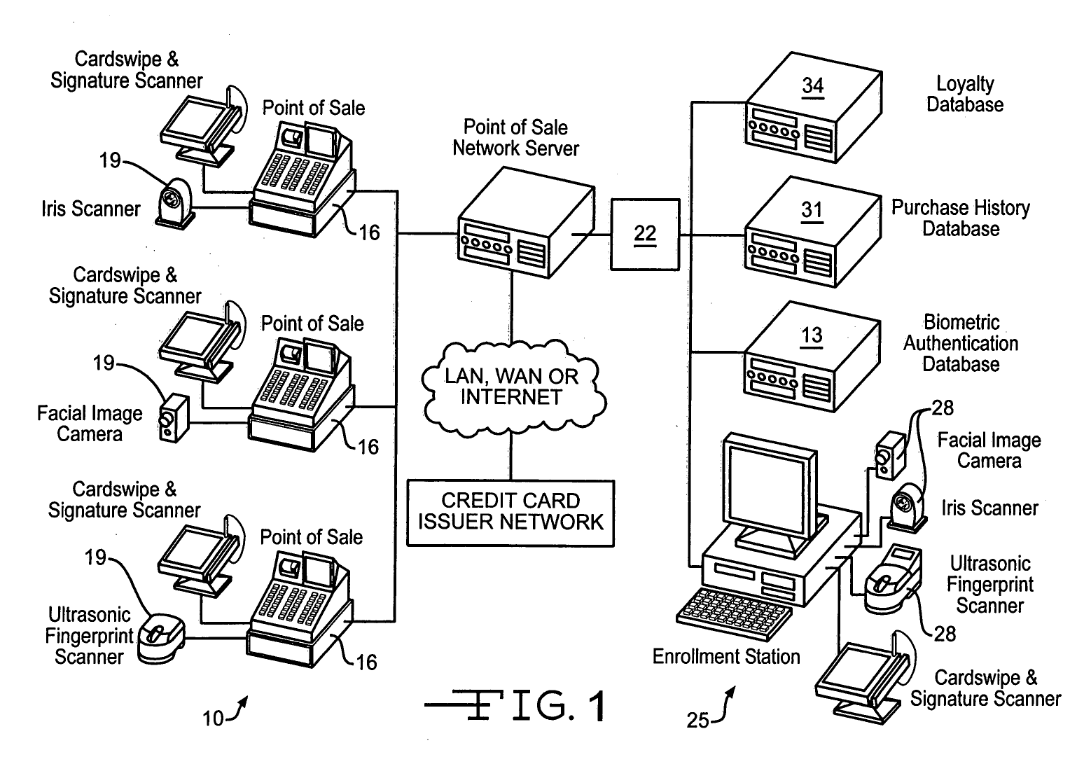

FIG. 2, which depicts a method according to the invention.

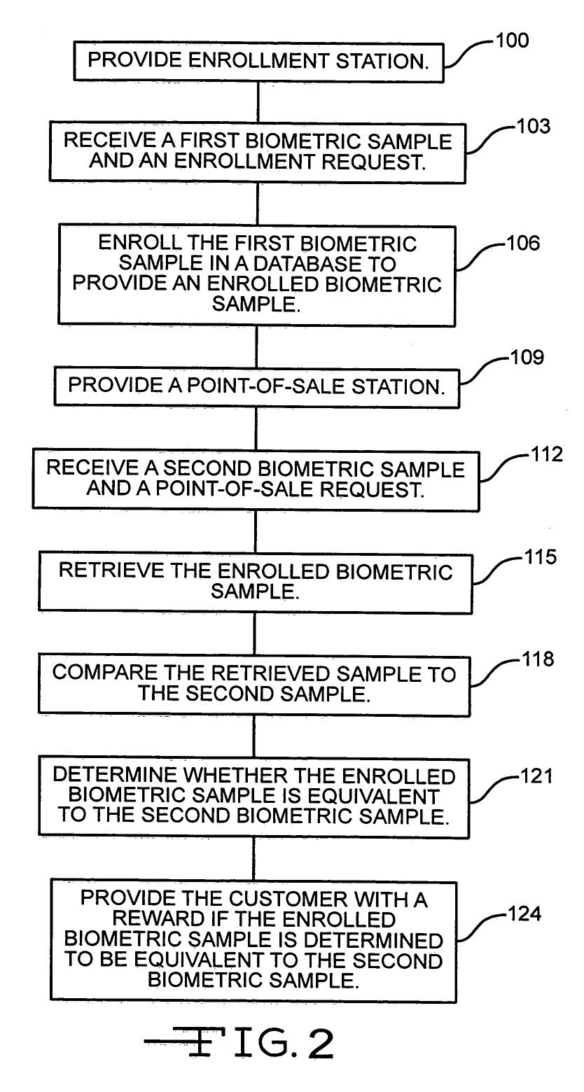

### FURTHER DESCRIPTION OF THE INVENTION

The invention may be embodied as a customer reward system 10. The customer reward system 10 may include a database 13 of enrolled biometric samples, a point-of-sale station 16 having a biometric-sample receiver 19, and a comparator 22. The comparator 22 may be in communication with the database 13 and the point-of-sale station 16. The comparator 22 may be a microprocessor programmed to compare a biometric sample received from the point-of-sale station 16 to biometric samples in the database 13. The comparator 22 may also be capable of determining whether the received biometric sample matches one of the biometric samples in the database 13. If the comparator 22 determines that the received biometric sample matches one of the biometric samples in the database 13, an authorization signal may be provided. The authorization signal may indicate that a reward should be provided. For example, the reward may be (a) a discount on items being purchased, (b) authorization of a check being used to pay for items being purchased, or (c) a service provided to a person that provided the biometric sample at the point-of-sale station.

The point-of-sale station 16 may be a check-out register. The check-out register may include a cash drawer and a scanner for scanning bar codes on items being purchased. The biometric sample receiver 19 may include a facial-image camera, an iris scanner, or an ultrasonic fingerprint scanner.

The customer reward system 10 may include an enrollment station 25 having a biometric sampler 28, such as a facial-image camera, an iris scanner, or an ultrasonic fingerprint scanner. Correspondingly, the enrolled biometric samples may include facial images, iris scans or ultrasonic fingerprint scans.

The customer reward system 10 may include a data base 31 of purchase information. Each piece of purchase information may be related to an enrolled biometric sample. When a customer uses the reward system 10 in conjunction with purchasing items, a record of the purchased items may be made in the purchase information database 31. The purchase information may be stored in the database 31 so as to identify information as being related to a particular person that provided an enrolled biometric sample. The information may be used to market goods or services to the person.

The reward system 10 may include a database 34 of other information, and that other information may be related to the person that supplied the biometric sample. For example, when a biometric sample is enrolled, the person supplying the biometric sample may be asked to also supply other information, such as their name, address, and/or number of children. Such other information may be related to the enrolled biometric sample. In this manner, the other information may be used in conjunction with the purchase information for marketing purposes.

The comparator 22 may execute different matching operations to determine whether the received biometric sample matches one of the enrolled biometric samples in the database 13. This may be accomplished by determining the type of reward being sought, and then providing a security indication related to the type of reward being sought. Using the security indication, a matching operation corresponding to the indication may be performed. In this manner, an extensive matching operation may be made when the security indication is high, and an abbreviated matching operation may be performed when the security indication is low. For example, if a customer desires to pay for products using a check, the security indication may be high to reflect that receipt of a bad check will cost the vendor money, and the corresponding matching operation may be more thorough. Alternatively, if a customer desires to receive a frequent shopper discount, the security indication may be low to reflect that providing the discount erroneously will not expose the vendor to significant financial loss, and the corresponding matching operation may be less thorough.

The invention may be embodied as a method. One such method provides 100 an enrollment station, and using that enrollment station to receive 103 a first biometric sample and an enrollment request. The enrollment station may have at least one of a facial-image camera, an iris scanner, or an ultrasonic fingerprint scanner. The first biometric sample may be enrolled 106 in a database to provide an enrolled biometric sample. The first biometric sample may be a facial image, an iris scan or an ultrasonic fingerprint scan. A point-of-sale station may be provided 109, and used to receive 112 a second biometric sample and a point-of-sale request. The point-of-sale station may be a check-out register. The request may be for a discount on items being purchased, authorization of a check being used to pay for items that are being purchased, or a service provided to the person that provided the second biometric sample. The enrolled biometric sample may be retrieved 115 and compared 118 to the second bio-metric sample. A determination 121 may be made as to whether the enrolled biometric sample is equivalent to the second biometric sample, and if the enrolled biometric sample is determined to be equivalent to the second biometric sample, then the customer may be provided 124 with a reward. If the enrolled biometric sample is determined not to be equivalent to the second biometric sample, then the reward may be denied.

When the reward is provided, purchase information may be obtained. For example, a list of the items purchased may be stored for later use. The stored purchase information may be identified as being related to the enrolled biometric sample that was used to authorize the reward.

In some situations, it may be advantageous to compile a list of possible types of rewards that could be provided to a particular customer. Compilation of that list may be done at the time of enrollment, or thereafter depending on the vendor's or customer's changing needs and desires. Then when it is determined that a reward should be provided, one of the rewards may be selected from the list.

A method according to the invention may be executed so as to perform different matching operations, depending on what type of reward is at issue. For example, one such method may determine the type of reward being sought, and provide a security indication related to the type of reward being sought. The security indication may be used to identify which matching operation should be performed in order to determine whether the biometric sample provided as the point-of-sale station is equivalent to a particular biometric sample in the database. The matching operation may be extensive if the security indication is high, or the matching operation may be abbreviated if the security indication is low.

Provisional patent application No. 60/549,758 describes embodiments of the invention. That provisional patent application is incorporated herein by reference.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

1. A customer reward system, comprising;
a database of enrolled biometric samples;
a point-of-sale station having a biometric-sample receiver;
a comparator in communication with the database and the point-of-sale station, the comparator being capable of (a) comparing a biometric sample received from the point-of-sale station to biometric samples in the database, and (b) determining whether the received biometric sample matches one of the biometric samples in the database, and (c) providing an authorization signal if the received biometric sample matches one of the biometric samples in the database, the authorization signal indicating that a reward should be provided.

2. The system of claim 1, wherein the reward is a discount on items being purchased.

3. The system of claim 1, wherein the reward is authorization of a check being used to pay for items being purchased.

4. The system of claim 1, wherein the reward is a service provided to a person that provided the second biometric sample.

5. The system of claim 1, further comprising an enrollment station having at least one of a facial-image camera, an iris scanner, or an ultrasonic fingerprint scanner.

6. The system of claim 1, wherein the enrolled biometric samples include facial images, iris scans or ultrasonic fingerprint scans.

7. The system of claim 1, wherein the point-of-sale station is a check-out register.

8. The system of claim 1, further comprising a data base of purchase information, each piece of purchase information being related to an enrolled biometric sample.

9. The system of claim 1, wherein the comparator is capable of determining whether a received biometric sample matches one of the biometric samples in the database by:
determining a type of reward being sought;
providing a security indication related to the type of reward being sought; and
performing a matching operation corresponding to the security indication.

10. The system of claim 9, wherein the comparator is capable of performing an extensive matching operation when the security indication is high, and an abbreviated matching operation when the security indication is low.

11. The system of claim 1, wherein the database of enrolled biometric samples includes one or more of the following information for at least one of the enrolled biometric samples: name of the person that supplied that biometric sample, address of the person that supplied the biometric sample, number of children of the person that supplied the biometric sample.

12. A method of rewarding a customer, comprising:
providing an enrollment station;
at the enrollment station, receiving a first biometric sample and an enrollment request;
enrolling the first biometric sample in a database to provide an enrolled biometric sample;
providing a point-of-sale station;
at the point-of-sale station, receiving a second biometric sample and a point-of-sale request;
retrieving the enrolled biometric sample and comparing the enrolled biometric sample to the second biometric sample;
determining whether the enrolled biometric sample is equivalent to the second biometric sample;
if the enrolled biometric sample is determined to be equivalent to the second biometric sample, then providing the customer with a reward, and denying the reward
if the enrolled biometric sample is determined not to be equivalent to the second biometric sample.

13. The method of claim 12, wherein the reward is a discount on items being purchased.

14. The method of claim 12, wherein the reward is authorization of a check being used to pay for items being purchased.

15. The method of claim 12, wherein the reward is a service provided to a person that provided the second biometric sample.

16. The method of claim 12, wherein the enrollment station includes at least one of a facial-image camera, an iris scanner, or an ultrasonic fingerprint scanner.

17. The method of claim 12, wherein the first biometric sample is a facial image, an iris scan or an ultrasonic fingerprint scan.

18. The method of claim 12, wherein the point-of-sale station is a check-out register.

19. The method of claim 12, further comprising obtaining purchase information if the enrolled biometric sample is equivalent to the second biometric sample.

20. The method of claim 19, further comprising storing the purchase information in a manner that identifies the purchase information as being related to the enrolled biometric sample.

21. The method of claim 12, further comprising:
compiling a list of possible types of rewards prior to receiving the second biometric sample;
selecting from the list if the enrolled biometric sample is determined to be equivalent to the second biometric sample.

22. The method of claim 12, wherein determining whether the enrolled biometric sample is equivalent to the second biometric sample includes:
determining a type of reward being sought;
providing a security indication related to the type of reward being sought; and
performing a matching operation corresponding to the security indication.

23. The method of claim 22, wherein an extensive matching operation is performed when the security indication is high, and an abbreviated matching operation is performed when the security indication is low.

24. A customer reward system, comprising;
a database of enrolled biometric samples;
a point-of-sale station having a biometric-sample receiver;
a comparator in communication with the database and the point-of-sale station, the comparator being capable of (a) determining a type of reward being sought, (b) providing a security indication related to the type of reward being sought, (c) performing a matching operation corresponding to the security indication to compare a biometric sample received from the point-of-sale station to enrolled biometric samples in the database, and (d) providing an authorization signal if the received biometric sample matches one of the enrolled biometric samples in the database, the authorization signal indicating that a reward should be provided.

25. The system of claim 24, wherein the comparator is capable of performing an extensive matching operation when the security indication is high, and an abbreviated matching operation when the security indication is low.
